(19) United States
(12) Patent Application Publication
(10) Pub. No.: US 2010/0192370 A1
(43) Pub. Date: Aug. 5, 2010

(54) METHOD AND DEVICE FOR PRODUCING A WIRE FROM COPPER OR FROM A COPPER ALLOY

(75) Inventors: Thomas Pfeffer, Frankfurt (DE); Reinhold Czieslick, Schluechtern (DE); Karl Goertz, Gelnhausen (DE)

Correspondence Address: SMITH, GAMBRELL & RUSSELL, 1130 CONNECTICUT AVENUE, N.W., SUITE 1130, WASHINGTON, DC, 20036, US

(73) Assignee: Umicore AG & Co. KG, Hanau-Wolfgang (DE)

(21) Appl. No.: 12/668,627

(22) PCT Filed: Jul. 11, 2008
(86) PCT No.: PCT/EP08/59062

§ 371 Date: Jan. 21, 2010

(30) Foreign Application Priority Data
Jul. 21, 2007 (DE) 10 2007 034 093.3

(51) Int. Cl. H01R 43/00

(52) U.S. Cl. 29/825

(57) ABSTRACT

The invention describes the production of a wire from copper or from a copper alloy in a continuous method, starting from an alloy block which is extruded in an extrusion press into a raw wire and is drawn, without interruption, to the finished dimension in a drawing apparatus.

The invention relates to a method and a device for producing wires from copper or from a copper alloy. The copper alloys suitable for this purpose are standardized, for example, in the standard DIN EN 1044. They contain in addition to copper, as alloying additives, cadmium, zinc, silicon, tin, manganese, nickel, silver, phosphorus and further nonferrous metals. Wires with diameters of 1 to 5 mm are usually produced from these alloys.

Methods and devices for producing wires and rods from copper or copper alloys are described, for example, in the German laid-open publication DE 39 29 287 A1 and DE 196 02 054 A1 and in U.S. Pat. No. 2,290,684 and U.S. Pat. No. 2,795,520. The starting point for producing the wires are, as a rule, cylindrical cast blocks which are heated to 550 to 600° C. and are extruded into one or more wires by means of an extrusion press. The raw wires obtained in this case usually have to be brought to the desired final diameters by means of further drawing or rolling processes.

Wires or rods having different cross-sectional shapes can be produced by means of the extrusion methods described. Round or square cross sections are used for preference. The extruded wires are usually brought to the finished dimension by single or multiple cold-drawing. During each drawing operation, where alloys are concerned, only cold forming with a degree of deformation between 25 and 30% is possible. The degree of deformation is dependent on the selected alloy. In the case of pure copper, an even higher degree of deformation can be achieved. The degree of deformation is defined as the ratio of the cross-sectional change in relation to the initial cross section.

Copper or copper alloys, at high temperatures, form a dark oxide skin consisting of Cu(II)oxide on the surface and tend towards embrittlement in the case of pronounced changes in shape during the drawing or rolling processes. Without further precautions to avoid these problems, the raw wires emerging from the extrusion press have to be pickled in dilute sulphuric acid to remove the oxide skin and then have to be rinsed with water. Embrittlement can be cancelled by annealing. The patent documents cited prevent the formation of the oxide skin by spraying the hot wires emerging from the extrusion press with water from suitable spray nozzles in order to obtain “metallically bare” wires.

Wires or rods having different cross-sectional shapes can be produced by means of the extrusion methods described. Round or square cross sections are used for preference. The extruded wires are usually brought to the finished dimension by single or multiple cold-drawing. During each drawing operation, depending on the material, only cold forming with a degree of deformation of between 25 and 50% is possible. The degree of deformation is in this case defined as the cross-sectional change in relation to the initial cross section.

According to experience, conventionally extruded wires have a width of fluctuation of their cross-sectional dimensions of ±5%. However, for copper alloys according to DIN EN 1044, the required limit dimensions for wires amount to ±3%. To adhere to the limit dimensions, a calibrating pass, as it is known, is first carried out before the finish-drawing, in order to reduce the tolerances of the cross-sectional dimensions. In this case, wire portions having a larger cross section are deformed to a greater extent than thinner wire portions. This leads to a different elongation at break, tensile strength and hardness along the wires. In general, harness and tensile strength increase with a rising degree of forming, whereas elongation at break decreases. Before the finish-drawing, therefore, the wires have to be intermediately annealed, so that the strain hardening which has occurred during forming is eliminated again by annealing above the recrystallization temperature.

The quality of extrusion therefore has a critical influence on the following operations.

Furthermore, it has been shown that the spraying, known from the prior art, of the extruded filler wires with cold water sometimes leads to speckled surfaces of the wires. Moreover, the wires thus produced are brittle and cannot be processed, without previous annealing, in subsequent drawing processes.

For drawing to the finished dimension, drawing apparatuses are available, the main part of which comprises what are known as drawing dies consisting of diamond or hard metal. They have a drawing orifice through which the wire is drawn. Since the drawing orifice is smaller than the wire diameter, the wire has to be pointed in a suitable device before it can be threaded through the drawing orifice. This operation is time-consuming and prevents a continuous manufacture from the cast block to the filler wire with the finished dimension.

The object of the present invention is therefore, to specify a continuous method for producing a wire from copper or from a copper alloy, in which a metallically bare wire with the finished dimension is produced without interruption, starting from the extrusion of a cast block, in only one following drawing operation.

This object is achieved by means of the method specified in the main claim. Preferred embodiments of the method are described in the subclaims.

The method according to the invention proceeds from the extrusion methods known from the prior art. Copper or copper alloy is introduced in the form of a cast billet into an extrusion press and is pressed, at a temperature of above 500° C., through a die having one or more die orifices and thereafter is cooled in a cooling zone. The raw wire or raw wires emerging from the die are drawn to the finished dimension in only one following drawing process. The method has the following steps:
a) protection of the hot wires emerging from the die, in a stretching zone (I), against oxidation by means of a protective gas;
b) cooling of the wires in a cooling zone (II) in a thermally controlled water bath at a temperature higher than 60° C.;
c) measurement of the cross-sectional dimensions of the wires after emergence from the water bath and exertion of a regulated tensile force on the wires, so that the deviations in the cross-sectional dimensions of the wires from a desired cross section due to the stretching of the wires in the stretching zone are minimized; and
d) introduction of the wires, without preceding pointing, into a divided drawing die, closing of the drawing die and drawing of the wires to the finished dimension, without interruption, until the cast billet is consumed.

A plurality of wires can be manufactured in parallel by means of this method. For this purpose, the die of the extrusion press must have a corresponding number of extrusion orifices. The die is preferably equipped with two extrusion orifices. For the sake of simplicity, the following explanations relate only to the production of one wire. In the production of a plurality of wires, the method sequences have to be carried out independently of one another for each wire.

By means of the method, wires with different cross-sectional shapes can be produced, preferably wires with a round cross section being produced.

According to the invention, a stretching zone is arranged between the die and the cooling zone. In the stretching zone, the temperature of the wire directly downstream of emergence from the die is still so high that the wire has a plastic consistency and can be drawn into length with relatively little effort. In this case, the cross-sectional dimensions of the wire are reduced, starting from the cross-sectional dimensions of the die orifice, to a desired cross section. This operation entails a manufacturing tolerance of about ±5%. It has been shown that the tolerance of the cross-sectional dimensions can be reduced to ±3% by the tensile force acting on the wire being regulated.

In the case of round wires, it has proved appropriate if the diameter of the die orifice is larger by the factor 1.4 to 2, preferably by the factor 1.5 to 1.8, than the desired wire diameter after the stretching zone is left. A larger die diameter diminishes the requirements with regard to the pressure force of the extrusion press.

The drawing speed for the wires downstream of the stretching zone preferably amounts to between 0.5 and 1.5, in particular to between 0.7 and 1.0 m/s.

The tensile force for the stretching operation can be introduced into the wire by means of a stretching drive arranged downstream of the cooling zone. To regulate the tensile force, the actual cross section after the emergence of the wire from the water bath and upstream of the stretching drive is measured and is compared with the desired cross section. The actual cross section forms the controlled variable, of which the deviation from the desired cross section is determined in a controller and is used to determine the necessary change in the tensile force of the stretching drive. The desired cross section of the wire may be determined, for example, by means of an optical wire-thickness meter.

The length of the stretching zone between die and cooling zone may be between 30 and 500 mm long, and it preferably has a length of 50 to 300 mm. Since the freshly extruded wire is still very hot in this zone, it is advisable to prevent oxidation on the wire surface by filling or flooding the stretching zone with a protective gas. Suitable protective gases are argon or nitrogen, nitrogen preferably being used.

The extrusion described, with a connected regulated stretching of the extruded raw wires, leads to wires, the thickness fluctuations of which are reduced to the extent that a single following drawing process is sufficient to draw the wires to their finished dimension. So that this drawing process can be connected directly, without interruption, after the cooling zone is left, the wire must leave the cooling zone in a metallically bare form. The term “metallically bare” is understood within the scope of this invention to mean that there is no black Cu(II)oxide on the surface of the filler wires, but only the unavoidable red Cu(I)oxide. The pickling of the wire for the purpose of removing the oxide skin may then be dispensed with.

According to the invention, the metallically bare surface of the wire is ensured downstream of the cooling zone, by means of several measures:
in the stretching zone, the wire is protected against oxidation by filling or flooding with an inert gas;
in the cooling zone, the wire will be cooled in a thermally controlled water bath at a temperature of above 60, preferably above 80° C., to below 100° C. For this purpose, the wires are preferably drawn through the water bath within 1 to 10 seconds;
preferably, the water bath is continually swirled, in order to prevent gas bubbles from being formed on the hot wire surface. This may take place, for example, by virtue of the fact that the hot water flows onto the wires transversely with respect to the running direction.

The above measures lead to filler wires with a metallically bare surface which still have a sufficient capacity for a change in shape for subsequent drawing processes. It is in this case essential that the water bath is thermally controlled to about 60 to 95° C. Temperatures of the water bath of below 60° C. lead to an embrittlement of the wire, which results in frequent wire breaks during the subsequent finish-drawing.

After the cooling of the wire in the water bath, it is drawn to the finished dimension in a single drawing process. So that this drawing process can be integrated uninterruptedly into the overall method, a divided drawing die was developed. The otherwise customary pointing of the wire and threading into the drawing die thereby become unnecessary. After the start of extrusion, the wire is introduced into the opened drawing die, the drawing die is closed and the wire is drawn to the finished dimension.

The method is suitable, in principle, for all extrusion methods in which an endless profile with reduced tolerances in the cross-sectional dimensions is to be produced. The method is preferably used, however, for the production of wires from copper or from copper alloys which, in addition to copper, contain alloying additives consisting of silver, cadmium, zinc, silicon, tin, manganese, nickel or phosphorus or combinations of these additives. The method makes it possible in a continuous operation to produce from a cast block a ready-to-use wire with a metallically bare surface.

The invention is explained in more detail below with reference to the examples and figures in which:

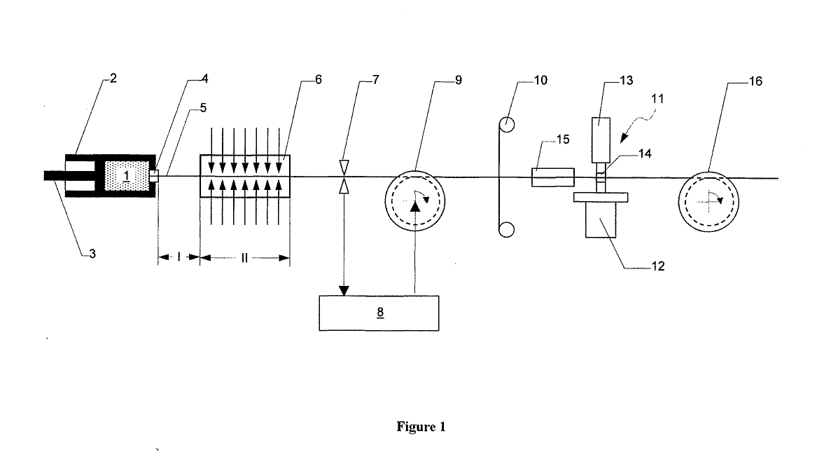

FIG. 1: shows a basic set-up for carrying out the method;

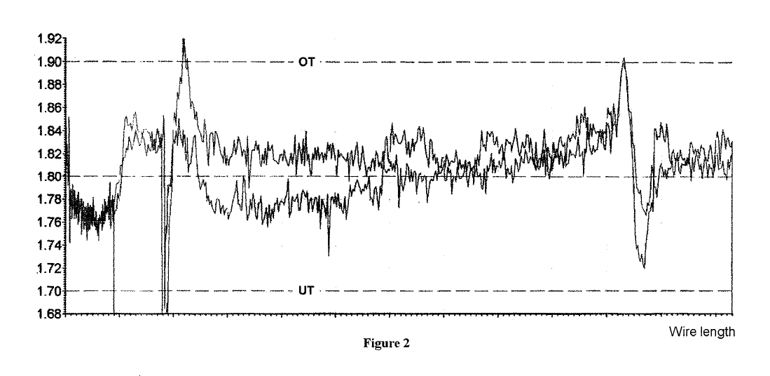

FIG. 2: shows a measurement log for the diameters of two parallel-drawn wires without a regulation of the stretching drive;

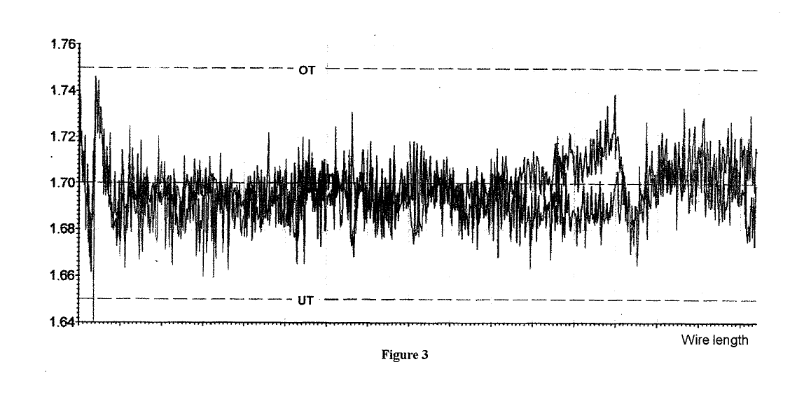

FIG. 3: shows a measurement log for the diameters of two parallel-drawn wires with a regulation of the stretching drive; and

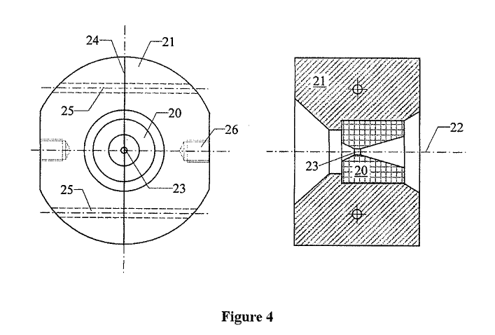

FIG. 4: shows a set-up of the divided drawing die.

FIG. 1 shows the basic set-up for carrying out the method. Reference numeral (1) designates the cast billet consisting of copper or of a copper alloy. It is located in the extrusion press (2) and is maintained at a temperature of, for example, 600° C. by means of external heating, not shown here. The cast billet is pressed through an orifice in a die (4) by means of the ram (3). The extruded raw wire is designated by reference numeral (5). The die (4) is followed by the stretching zone (I) in which the wire is only moderately cooled. To avoid oxidation of the wire, the stretching zone is, for example, filled or flooded with a protective gas. In the following cooling zone (II), the still hot wire is cooled to a temperature of below 100° C. by being led through a thermally controlled water bath (6) which is maintained at a temperature of at least 60° C. The water bath is illustrated in a top view of the water surface. The arrows directed towards the raw wire (5) from opposite sides illustrate a flow of water onto the wire from a plurality of nozzles which are arranged along the wire in the water bath. The water necessary for this purpose is circulated. For this purpose, on the bottom of the water bath, an outflow is located, via which a pump sucks away water and feeds it again to the water bath via the flow nozzles. The transverse flow onto the wires prevents gas bubbles from settling on the wire surfaces and leading to a speckled surface.

Downstream of the cooling zone (II) is arranged a measurement system (7) for determining the cross-sectional dimensions of the wire. Mechanical or optical measurement systems are suitable. The measurement signal is compared in the controller (8) with the value for the desired cross section and from the resulting control deviation a manipulated variable is transmitted to the drive motor of the stretching drive (9). If the measured cross section is larger than the desired cross section, the tensile force of the stretching drive is increased, thus leading to an elongation with a corresponding reduction in the cross section. If, conversely, the measured cross section is smaller than the desired cross section, the tensile force of the stretching drive is reduced. By means of this regulation, the tolerance of the cross-sectional dimensions of the extruded wire can be reduced from ±5% to less than ±3%.

In a following processing station (11), the wire is drawn to the finished dimension. This processing station consists of a press with a bottom ram (12) and a top ram (13). The main part of this processing station comprises an arrangement consisting of a drawing die and of a holder. The drawing die and holder are divided in order to make it possible, during continuous extrusion, to introduce the wire extruded by means of the extrusion press. One half of the arrangement (14) is fastened in each case to the bottom ram and the top ram. Before the commencement of the extrusion of the raw wire, the two rams of the press are moved apart from one another. When the raw wire reaches this press, it is introduced into the open drawing die and the start of the wire is wound, downstream of the drawing die, around the drawing drive (16). The top ram of the press is then lowered onto the bottom ram until the two parting planes of the drawing die lie one on the other. The drawing drive draws the wire through the drawing die to the finished dimension. The finished filler wire is wound onto a winder, not shown in FIG. 1.

The extrusion speed, stretching and drawing to the finished dimension are coordinated with one another throughout the duration of the method, so that the cast billet can be extruded, without interruption, with the exception of an unavoidable residue. The drawing speed of the wires downstream of the cooling zone preferably amounts to between 0.5 and 1.5 m/s.

In order to make it easier to start up the process, downstream of the first winding drive a jockey (10), as it is known, is located, which can compensate brief speed differences between the individual processing stations of the method. Reference numeral (15) designates a wire guide combined with a lubricating station.

FIG. 4 shows the arrangement consisting of the drawing die and of the holder. It consists of the drawing die (20) which is fastened in a holder (21). The drawing die has a bore (23), the axis of which forms a drawing axis. The drawing die and holder are divided along the drawing axis. During wire drawing, the two halves of the arrangement lie, with the parting planes (24), which have occurred during division, one on the other and are positioned exactly with respect to one another by means of pins in the pin holes (25). The threaded holes (26) in the holder serve for fastening the halves of the arrangement in the top ram and bottom ram of the press.

The drawing die may consist of hard metal or of diamond, preferably of a polycrystalline diamond.

So that no scores are generated on the wire due to the division of the drawing die during wire drawing, the bore of the drawing die must be manufactured exactly. The procedure in this case is preferably such that, first, a preform of the drawing die, without a bore, is fastened in the undivided holder. The drawing die is preferably soldered into a holder consisting of steel. After the pin holes have been introduced into the holder, the arrangement is divided along the later drawing axis, and the parting planes are smoothed. After the pinning of the two halves of the arrangement, the drawing orifice is produced conventionally, as also in the case of undivided drawing dies.

Surprisingly, it was shown that no scores as a result of the division of the drawing die can be detected on the wires drawn by means of such a drawing die. The particular advantage of this drawing die is that the raw wire does not have to be pointed in order to be threaded into the drawing orifice. By the pointing of the raw wire being omitted, it is then possible to set up a drawing plant, by means of which a raw wire can be drawn in a drawing station up to the finished wire continuously and without any interruption for the purpose of pointing the wire.

In the following comparative example and example, raw wires consisting of the copper alloy Ag40Cu30Zn28Sn2 (designation according to DIN EN 1044: AG 105) were extruded. These raw wires were then finish-drawn to a wire diameter of 1.5 mm.

### COMPARATIVE EXAMPLE

A 40 kg cast billet consisting of the said copper alloy was extruded in an extrusion press through a die with two rounded die orifices, each with a diameter of 2.9 mm, into two parallel wires. In the stretching zone, the wire diameters were reduced to a desired dimension of 1.8 mm by a constant tensile force being applied.

The speed of the extruded wires downstream of the stretching zone was 1 m/s.

FIG. 2 shows the diameter values, detected by means of an optical measurement system, against a wire length of 880 m. In FIG. 2, the upper tolerance limit (OT) is depicted at 1.9 mm and the lower tolerance limit (UT) at 1.7 mm. These values correspond to a thickness tolerance of about ±5%.

In this extrusion test, the desired dimension of the wire diameters was set at 1.8 mm, in order, even in the case of pronounced fluctuations in the diameters, still to have a sufficient change in shape available for the calibrating pass and a finish-draw to a diameter of 1.5 mm.

By means of the calibrating pass, the wires were drawn to a diameter of 1.7 mm. On account of the high diameter fluctuations of the extruded wires, corresponding fluctuations in hardness, tensile strength and elongation at break were introduced into the wires by means of the calibrating pass. These various mechanical properties were compensated by intermediate annealing above the recrystallization temperature before the wires were finish-drawn to a diameter of 1.5 mm.

### Example 1

The comparative example was repeated with a second cast billet. In contrast to the comparative example, in this case the tensile force was regulated. The desired diameter of the wires was 1.7 mm. The measurement results for the diameters of the two wires are shown in FIG. 3 against a length of 980 m. Upper and lower tolerance limits are again depicted in FIG. 3. The upper tolerance limit lay at 1.75 and the lower at 1.65 mm, corresponding to a diameter tolerance of ±3%.

The diameter tolerance, reduced by means of the method according to the invention, of the raw wire made it possible to lower the mean diameter of the raw wire from 1.8 to 1.7 mm, without any loss of sufficient change in shape, during finish-drawing to a diameter of 1.5 mm. The calibrating pass and intermediate annealing, as in the comparative example, were not necessary here.

### Example 2

In the test series described below, raw wires consisting of the copper alloy Ag40Cu30Zn28Sn2 (designation according to DIN EN 1044: AG 105) with a metallically bare surface were drawn. These raw wires were then finish-drawn to a wire diameter of 1.5 mm.

A 10 kg cast billet consisting of the said copper alloy was extruded in the extrusion press through a die with two round die orifices, each with a diameter of 2.9 mm, into two parallel wires. In the stretching zone, the wire diameters were reduced to a desired dimension of 1.7 mm by a regulated tensile force being applied. The stretching zone was protected against atmospheric oxygen by a throughflow of nitrogen. The stretching zone issued directly into a thermally controlled water bath. For swirling the water, the bath was equipped with a cross-flow device. The speed of the wires led through the water bath was 1 m/s.

A plurality of cast billets were extruded by means of the apparatus described at different temperatures of the water bath. The filler wires thus extruded, with a bare surface, were subsequently drawn in a drawing apparatus down from 1.7 mm to 1.5 mm diameter and their drawing behaviour was assessed qualitatively. The results are found in the following table.

TABLE
Drawing behaviour of the extruded wires as a
function of the temperature of the water bath

| | Test no. 1 | Test no. 2 | Test no. 3 | Test no. 4 |
|---|---|---|---|---|
| | Water temperature | | | |
| | 20° C. | 40° C. | 60° C. | 80° C. |
| Drawing | Wire is brittle. | Occasional | Wire can | Good |
| behaviour | Frequent wire | wire breaks | be drawn | |
| | breaks during | during drawing | without breaks | |
| | drawing | | | |

1. Continuous method for producing wires from copper or from a copper alloy, the copper or copper alloy being in the form of a cast billet and being finish-drawn into one or more wires at a temperature of above 500° C. with the aid of an extrusion press, in which a die is located, and corresponding drawing dies, characterized by the following steps:
a) protection of the hot wires emerging from the die, in a stretching zone (I), against oxidation by means of a protective gas;
b) cooling of the wires in a cooling zone (II) in a thermally controlled water bath at a temperature higher than 60° C.;
c) measurement of the cross-sectional dimensions of the wires after emergence from the water bath and exertion of a regulated tensile force on the wires, so that the deviations in the cross-sectional dimensions of the wires from a desired cross section due to the stretching of the wires in the stretching zone are minimized; and
d) introduction of the wires, without preceding pointing, into a divided drawing die, closing of the drawing die and drawing of the wires to the finished dimension, without interruption, until the cast billet is consumed.

2. Method according to claim 1, characterized in that gas bubbles on the surface of the wires are prevented by water flowing onto the wires transversely with respect to their longitudinal extent.

3. Method according to claim 1, characterized in that the drawing speed downstream of the stretching zone amounts to between 0.5 and 1.5 m/s.

4. Method according to claim 1, characterized in that the length of the stretching zone between die and cooling zone amounts to 30 to 500 mm.

5. Method according to claim 4, characterized in that the stretching zone is filled or flooded with a protective gas in order to prevent oxidation of the hot wire.

6. Method according to claim 1, characterized in that the tensile force is introduced into the wire by means of a stretching drive arranged downstream of the water bath.

7. Method according to claim 1, characterized in that the cross section of the wire is round.

8. Method according to claim 7, characterized in that the diameter of the die orifice is larger by the factor 1.4 to 2 than the desired wire diameter after the stretching zone is left.

9. Method according to claim 8, characterized in that a plurality of wires are extruded simultaneously, using a die with a plurality of die orifices.

10. Method according to claim 1, characterized in that the copper alloy contains, in addition to copper, alloying additives selected from the group consisting of silver, cadmium, zinc, silicon, tin, manganese, nickel, phosphorus and combinations thereof.
